(19) United States
(12) Patent Application Publication
(10) Pub. No.: US 2019/0228059 A1
(43) Pub. Date: Jul. 25, 2019

(54) METHOD AND SYSTEM FOR CREATING AND MANAGING A CONTENT MARKETPLACE

(71) Applicant: Tal FLORENTIN, Petach Tikva (IL)

(72) Inventor: Tal FLORENTIN, Petach Tikva (IL)

(21) Appl. No.: 16/313,030

(22) PCT Filed: Jun. 28, 2017
(86) PCT No.: PCT/IB2017/053866

§ 371 Date: Dec. 23, 2018

Related U.S. Application Data
(60) Provisional application No. 62/355,354, filed on Jun. 28, 2016.

(51) Int. Cl. G06F 17/24; G06F 17/27; G06F 17/22

(52) U.S. Cl. CPC G06F 17/24; G06F 17/2205; G06F 17/27

(57) ABSTRACT

The present invention provides methods, systems, and products, such as software products, for providing a marketplace for summarized content for consumers. The methods, systems and software products are such that received or inputted content is automatically analyzed and a summarizer, such as an individual (manual, e.g., human) or automatic summarizer is determined and/or selected to be the summarizer for the received content. The received content is transmitted to the selected summarizer for summarization, e.g., creation of a summary of the received content. A summary of the received content is then received from the summarizer (who transmits the summarized content to the system), and the summary of the content (e.g., the summarized content) is rendered to a medium such that the summary is accessible to consumers.

### TECHNICAL FIELD

The present invention is directed to systems and methods for creating, managing and administering a content marketplace over one or more communications networks.

### BACKGROUND

With the advent of electronic media, users are exposed to exceedingly large amounts of content. Typically, these users do not have time to read all of the content and do not have any way to determine which content is relevant. Accordingly, users like summaries of content, which are quick to read, and from such summaries, the user can get the main points and take-aways from the content, to determine whether they want the full content, which they can read immediately, or at a later point in time.

### SUMMARY

The present invention provides methods, systems, and products, such as software products, for providing a marketplace for summarized content. The present invention also provides the aforementioned summarized content in terms of key sentences or phrases, so that a reader can get a general idea of the content from these sentences or phrases. The aforementioned summarized content can be in multiple forms (formats), including text, vocal (audio/speech) and visual (video), and combinations thereof.

Embodiments of the invention are directed to a method for providing summarized content for consumers. The method comprises: receiving content, for example, content inputted by summary requesters, automatically analyzing the content; automatically determining the summarizer for the content based on the analysis of the content; automatically sending the content to the determined summarizer for summarization; receiving a summary of the content from the summarizer; and, rendering the summary of the content to a medium such that the summary is accessible to consumers.

Optionally, the automatically analyzing the content includes analyzing the content for one or more of subjects, keywords and phrases.

Optionally, the automatically determining the summarizer for the content includes selecting at least one of an automatic summarizer or a manual summarizer for the content.

Optionally, the automatically sending the content to the determined summarizer includes: 1) sending the content to a selected individual summarizer; or, 2) sending the content to a storage media for access by multiple summarizers, when a manual summarizer for the content has been selected.

Optionally, upon receiving a summary of the content from the summarizer, providing the summary to a voice artist interface for access by voice artists to provide audio to the content.

Optionally, the summary including the audio is received from the voice artist, such that the summary can be rendered to the medium such that the summary is accessible to consumers.

Optionally, the rendering the summary of the content to a medium includes providing the summary of the content to a storage media.

Optionally, the storage media includes one or more of a marketplace server and an archive server.

Optionally, the rendering the summary of the content to a medium includes transmitting the summary of the content to a device associated with at least one of the consumers.

Optionally, the transmission is performed automatically.

Optionally, the summary of the content is in at least one format including, text, audio, video, and combinations thereof.

Embodiments of the invention are directed to a computerized system for providing summarized content for consumers. The system comprises: a storage medium for storing computer components; and, a computerized processor for executing the computer components. The computer components comprise: a first computer component for receiving content, for example, which has been input or otherwise entered into the system; a second computer component for automatically analyzing the content; a third computer component for automatically determining the summarizer for the content based on the analysis of the content; a fourth computer component for automatically sending the content to the determined summarizer for summarization; a fifth computer component for receiving a summary of the content from the summarizer; and, a sixth computer component for rendering the summary of the content to a medium such that the summary is accessible to consumers.

Optionally, the second computer component for automatically analyzing the content analyzes the content for one or more of subjects, keywords and phrases.

Optionally, the third computer component for automatically determining the summarizer for the content selects at least one of an automatic summarizer or a manual summarizer for the content.

Optionally, the fourth computer component for automatically sending the content to the determined summarizer: 1) sends the content to a selected individual summarizer; or, 2) sends the content to a storage media for access by multiple summarizers, when a manual summarizer for the content has been selected.

Optionally, the computerized system additionally comprises: a seventh computer component for providing the summary to a voice artist interface for access by voice artists to provide audio to the content, for a received summary of the content from the summarizer.

Optionally, the fifth computer component additionally receives the summary including the audio from the voice artist, such that the summary can be rendered to the medium such that the summary is accessible to consumers.

Optionally, the sixth computer component renders the summary of the content to a medium by providing the summary of the content to a storage media.

Optionally, the storage media includes a marketplace server.

Optionally, the sixth computer component renders the summary of the content to a medium by transmitting the summary of the content to a device associated with at least one of the consumers.

Optionally, the transmission is performed automatically.

Optionally, the computerized system is such that the summary of the content is in at least one format including, text, audio, video, and combinations thereof.

Embodiments of the invention are directed to a computer usable non-transitory storage medium having a computer program embodied thereon for causing a suitable programmed system to providing summarized content for consumers via a network, by performing the following steps when such program is executed on the system. The steps comprise: receiving content; automatically analyzing the content; automatically determining the summarizer for the content based on the analysis of the content; automatically sending the content to the determined summarizer for summarization; receiving a summary of the content from the summarizer; and, rendering the summary of the content to a medium such that the summary is accessible to consumers.

Optionally, the computer usable non-transitory storage medium is such that the automatically analyzing the content includes analyzing the content for one or more of subjects, keywords and phrases.

Optionally, the computer usable non-transitory storage medium is such that the automatically determining the summarizer for the content includes selecting at least one of an automatic summarizer or a manual summarizer for the content.

Optionally, the computer usable non-transitory storage medium is such that the automatically sending the content to the determined summarizer includes: 1) sending the content to a selected individual summarizer; or, 2) sending the content to a storage media for access by multiple summarizers, when a manual summarizer for the content has been selected.

Optionally, the computer usable non-transitory storage medium is such that, upon receiving a summary of the content from the summarizer, providing the summary to a voice artist interface for access by voice artists to provide audio to the content.

Optionally, the computer usable non-transitory storage medium is such that the summary including the audio is received from the voice artist, such that the summary can be rendered to the medium such that the summary is accessible to consumers.

Optionally, the computer usable non-transitory storage medium is such that the rendering the summary of the content to a medium includes: 1) providing the summary of the content to a storage media; or, 2) automatically transmitting the summary of the content to a device associated with at least one of the consumers.

Optionally, the computer usable non-transitory storage medium is such that the storage media includes a marketplace server.

Optionally, the computer usable non-transitory storage medium is such that the summary of the content is in at least one format including, text, audio, video, and combinations thereof.

This document references terms that are used consistently or interchangeably herein. These terms, including variations thereof, are as follows.

A “computer” includes machines, computers, and computing or computer systems (for example, physically separate locations or devices), servers, computer, computing, and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smart phone (cellular and network linked), smart band, smart watch, virtual and augmented reality headsets, personal digital assistant (PDA)).

A “server” is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software based emulation of a computer.

An “application”, includes executable software, and optionally, any graphical user interfaces (GUI), through which certain functionality may be implemented.

A “client” is an application that runs on a computer, workstation, tablet, smartphone, or any other digital device, or the like and relies on a server to perform some of its operations or functionality.

A “link” is an electronic reference to another electronic or digital media, such as a document, file or other media. A “link”, when activated, such as by being “clicked on” by a mouse or other pointing device, or swiped or contacted on a toch screen, such as that of a mobile device, such as a smart phone, redirects a user's computer browsing application (browser) to the document, file or other media.

“n” and “nth” refer to the last member of a varying or potentially infinite series.

The terms “click”, “clicks”, “click on”, “clicks on”, “activates”, and “activation”, involves the activation of a computer pointing apparatus, such as a device commonly known as a mouse, or a touch, swipe, contact, or the like on a touch screen, on a location on a computer screen display, including screen displays of tablets and mobile telephones. The screen displays are activatable, for example, by an activatable icon, such as buttons, that causes an action of the various software and or hardware, including that for executing applications and supporting the computer screen display.

A Uniform Resource Locator (URL), is also referred to as a web address, and is a reference to a web resource that specifies its location on a computer network and a mechanism for retrieving it. URLs typically occur to reference web pages (Hypertext Transfer Protocol (HTTP)), but are also used, for example, for file transfer (File Transfer Protocol (FTP)), email (mailto), and database access (Java Database Connectivity (JDBC))—an application programming interface (API) for the programming language Java).

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram of an exemplary environment for the system in which embodiments of the disclosed subject matter are performed;

FIG. 2 is a diagram of the architecture of the local computer, having downloaded the program of the present invention;

FIGS. 3A and 3B, collectively referred to as FIG. 3, form a flow diagram of an example process in accordance with embodiments of the present invention,

FIGS., 3C-1, 3C-2 and 3C-3 are screen shots (screen diagrams) of a summarizer platform in accordance with embodiments of the present invention;

FIGS. 3D-1 and 3D-2 are screen shots (screen diagrams) of a voice artist interface platform in accordance with embodiments of the present invention;

FIG. 4 is a screen diagram of a web page including a browser extension in accordance with embodiments of the present invention;

FIGS. 5A-1, 5A-2 and 5A-3 are screen shots (screen diagrams) of am example account of a user who has purchased or otherwise obtained access to the summaries of the system in accordance with embodiments of the present invention;

FIGS. 5B-1, 5B-2 and 5B-3 are screen shots (screen diagrams) of displays for knowledge pack management by the system, in accordance with embodiments of the present invention;

FIGS. 5C-1 to 5C-5 are screen shots (screen diagrams) of displays for conference pack creation, editing and management by the system, in accordance with embodiments of the present invention;

FIGS. 5D-1 to 5D-4 are screen shots (screen diagrams) of displays for conference pack usage in accordance with embodiments of the present invention;

FIG. 5E is a screen shot (screen diagram) of a display of a user account for curators being followed by a user;

FIGS. 5F-1, 5F-2, and 5F-3 are screen shots (screen diagrams) of displays for curator management in accordance with embodiments of the present invention; and,

FIGS. 6A, 6B and 6C are screen shots of a mobile interface in accordance with embodiments of the present invention.

### DETAILED DESCRIPTION OF THE INVENTION

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable (storage) medium(s) having computer readable program code embodied thereon.

Throughout this document, numerous textual and graphical references are made to trademarks, and domain names. These trademarks and domain names are the property of their respective owners, and are referenced only for explanation purposes herein.

The present invention provides methods, systems, and products, such as software products, for providing a summarized content for consumers. The methods, systems and software products are such that received (input) content is automatically analyzed, and a summarizer, such as an individual (manual, e.g., human) or automatic summarizer, is determined and/or selected to be the summarizer for the received (input) content. The received content is transmitted to the selected summarizer for summarization, e.g., creation of a summary of the received content. A summary of the received content is then received from the summarizer (who transmits the summarized content to the system), and the summary of the content (e.g., the summarized content) is rendered to a medium such that the summary is accessible to consumers.

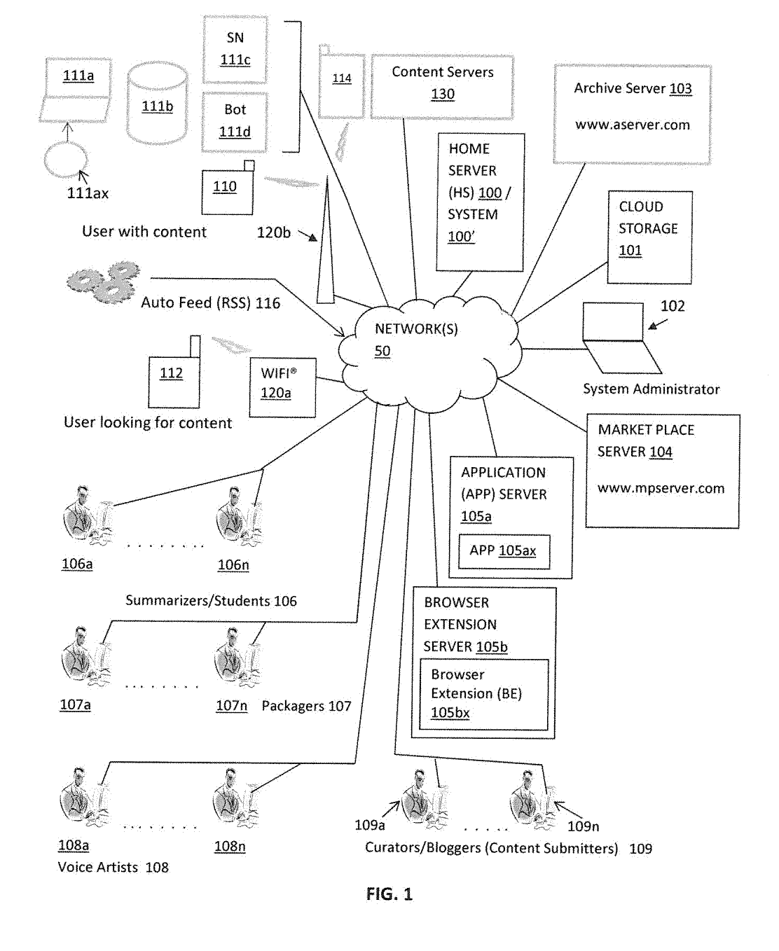

Reference is now made to FIG. 1, which shows an operating environment for a non-limiting exemplary system, in which the present invention is applicable. The invention handles content and produces and warehouses summaries of the content, available to both specific users, as well as other or general users.

Throughout this document, “summaries” of content, produced and administered by the invention, are also known as “summarized content”, and “summarized content items”, in singular and plural forms, and these terms, “summaries”, “summarized content”, and “summarized content items”, are used interchangeably herein.

Communication between computers, servers and the like of the various entities associated with the invention is via one or more communications networks, represented by the network(s) 50. The aforementioned computers, servers and the like of the various entities associated with the invention are linked to the one or more networks, represented by the network(s) 50, either directly or indirectly. “Linked” as used herein includes both wired or wireless links, either direct or indirect, and placing the computers, including, servers, components and the like, in electronic and/or data communications with each other. The network(s) 50 is, for example, a communications network, such as a Local Area Network (LAN), or a Wide Area Network (WAN), including public networks such as the Internet. As shown in FIG. 1, the network 50 is, for example, the Internet. The network(s) 50, although shown as a single network, may be a combination of networks and/or multiple networks including, for example, the Internet and cellular networks.

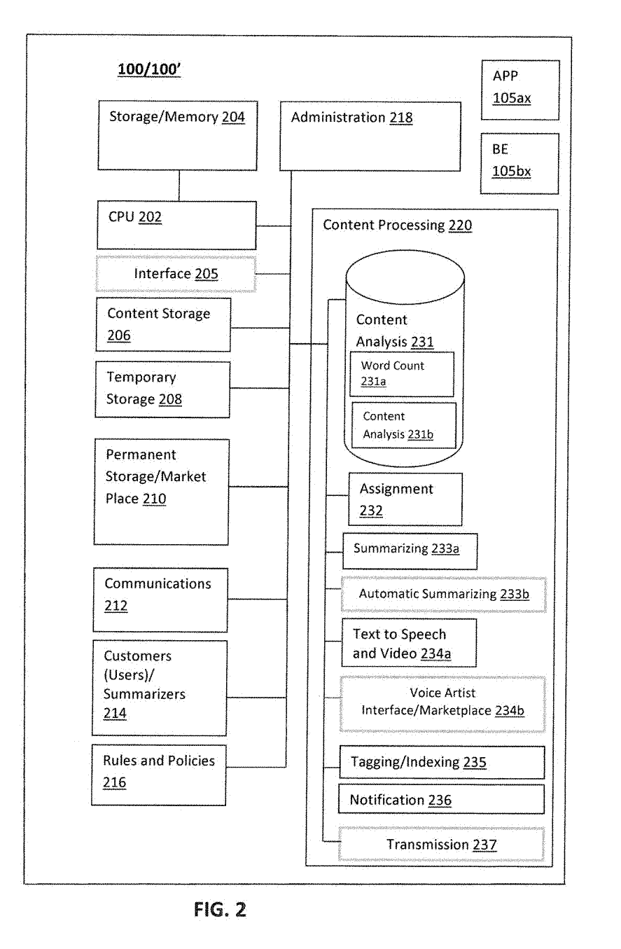

A home server (HS) 100, also known as a main server, includes a system 100′ (FIG. 2). The system 100′ performs processes of the invention, and is linked to the network(s) 50. A system administrator, represented by computer 102, who is any entity associated with the system 100′ and who may provide editing, quality control, or the like, to the summarized content, once received from summarizers (represented by computers 106a-106n) and packagers 107a-107n, has his computer linked to the network(s) 50. The system administrator 102 typically also manages all processes associated with the system 100′ including managing voice artists 108, managing creators of knowledge packs (packagers 107), conference packs, subscriptions, content submitters 109, such as curators and bloggers, and tracking them.

There is also a cloud storage server 101, linked to the network(s) 50, representative of storage media for storing content and summarized content produced in accordance with the invention, and associated metadata. There is also an archive server 103, linked to the network(s) 50, that serves as an archive for all summaries, and is detailed further below.

A Market Place server 104 is linked to the network(s) 50. An application server 105a from which applications (APP) 105ax can be downloaded and a browser extension server 105b, from which a browser extension (BE) 105bx can be downloaded, are also linked to the network(s) 50. There is also a content server 130, representative of various servers, from which content such as various electronic documents, media, e.g., audio, video, movies, and the like, can be obtained, and which is linked to the network(s) 50. This content may be provided to the system 100′ for summarization.

The summarizers/students, collectively “summarizers” 106, represented by their computers 106a-106n are also linked to the network 50, as are the computers 107a-107n of packagers 107, computers 108a-108n of voice artists (or narrators) 108, and computers 109a-109n of content submitters such as curators and bloggers 109. The computers 110 (including devices 111a-111d), 112 of users, who are, for example, content requestors such as: 1) device 110, representative of entities requesting their content, which they submit (as URLs, e.g., links, text and text summaries, videos, audio files) to the system 100′, be summarized by the system 100′ of the invention, or, 2) device 112, representative of an entity requesting summarized content from the marketplace server 104, which may be in storage media associated with the system 100′. Computer 114, for example, is a smart phone associated with a user seeking to see what summarized content is in the market place, or a customer of the system 100′. The computers 110, 112, 114 and the associated users typically request or seek to obtain summarized content produces and provided by the system 100′ and as such are also known as end users or consumers (content consumers). Throughout this document, elements 102, 106a-106n, 107a-107n, 108a-108n, 109a-109n, 110 (and 111a-111d), 112 and 114 represent individual users as well as associated computers. The computers 106a-106n, 107a-107n, 108a-108n, 109a-109n, 110 (and 111a-111d), 112 and 114, link to the network(s) 50 via Wifi® 120a and cellular towers 120b.

While a smartphone 110 is shown as representative, alternatively, content can also be entered into the system 100′ by entities/devices such as desktop/laptop/tablet computers 111a (the desktop/laptop/tablet computer 111a, a voice activated device 111b, such as Alexa™ from Amazon of Seattle Wash., social media 111c, for example, Facebook®, and bots 111d, such as chat bots, all of which are linked to the network(s) 50. The computer 111a can also accept media with recorded materials thereon, represented, for example, by compact disks (CDs) 111ax and the like. Additionally, the smart phone 110 and the computers 111a can be associated with web sites, from which content can be entered into the system 100′, and also allow the browser extensions 105bx and add-ons, that allow for sending links (to content, such as that stored in content servers 130), to the system 100′. The voice activated device 111b can also obtain links, content and the like, and cause its transmission to the system 100′. The content can also be entered via social networks (SN) 111c and bots 111d.

The content which any one or more of components 110 and 111a-111d input into the system 100′ is from sources, including, for example, URLs, e.g., links, original text, from content servers 100 or recorded media, represented by the compact disk 111ax, original summaries, online and off-line: 1) videos, 2) movies, 3) audio files, blog posts, online articles, ebooks, academic and scholarly papers, podcasts and other sources, both on-line and off-line.

The content is input (loaded) into the system 100′ by numerous methods including, for example, uploading, pasting text into interfaces 205 (FIG. 2), writing it into a form, and the like. Content can also be auto loaded via installed add-ons or browser extensions and the like.

Content is also input into the system 100′ via auto-feeds 116, for example, content from on-line content providers, such as CNN® (www.cnn.com), BBC® (www.bbc.com), and the like, via RSS (Rich Site Summary).

The home server 100, cloud server 101, market place server 104, application server 105a and browser extension server 105b, utilize hardware, software, processors and various storage media for performing their respective operations, as detailed below.

The application (APP) 105ax, downloadable from either the home server 100 or the application server 105a is such that it embeds or integrates with the hardware and software, e.g., code, of the respective user computers 110, 112. The now downloaded application on the user computer 110, 112, operates, for example, as a client, and the respective user computers 110, 112 are, for example, operating as client computers. The client, in some cases, is part of the system 100′. The application 105ax, when downloaded onto a user computer 110, 112, is such that when the user has obtained digital content on his computer 110, 112, he activates the now-running application (e.g., the device's share option), and the application 105ax submits the content, via a URL, or automatic or manual administered submission of the summarized content itself (rather than a link to the content) e.g., a link to the content, as original text, an original summary, a video, movie, or an audio file, to the system 100′, for processing in accordance with the present invention. The application 105ax is, for example, also such that the user 110, 112 may receive a User Interface (UI) for categorizing the content and, optionally, approving its credits before submission, or accessing the web for purchasing additional credits.

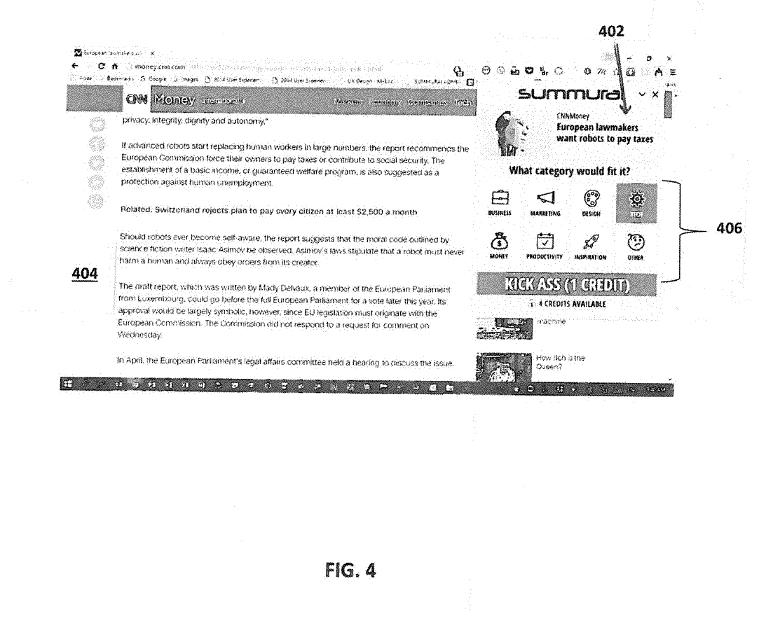

The browser extension (BE) 105bx, downloadable from either the home server 100 or the browser extension server 105b, is such that it embeds or integrates with the hardware and software, e.g., code, of the respective user computers 110, 112. The browser extension 105bx, or installed add-ons for email clients such as Gmail® or Microsoft® Outlook® and the like or add-ons or extensions for content platforms or social media platforms such as Facebook® (www.facebook.com) and the like. When the browser extension 105bx is downloaded and installed onto a user computer 110, 112, such that when the user browses content on the browser (browsing application) of his computer 110, 112, the now running browser extension 105bx submits content, for example, via a URL, e.g., a link to the content, as original text, an original summary, a video or an audio file for the browsed content, to the system 100′, when the user activates, e.g., “clicks”, on a button. The activation of this button opens the browser extension 402, on the web page 404 with the content being viewed, as shown in FIG. 4. The now-opened browser extension screen 402 allows the user to select a category 406 and submit the content, to the system 100′.

Optionally, when the user has no credits, he gets an ability to purchase credits from the system 100′, for example, via the administration module 218. The extension 404, for example, also manages user credentials, tracks summary status, and accesses previous summaries.

Similarly, the computers 104, 106a-106n, 107a-107n, 108a-108n, 109a-109n, 110, 112, 114 include hardware, software, browsing applications, processors and various storage media for performing its operations.

Additionally, and as discussed below, within the system 100′, summarized content is produced. This summarized content is in various forms, including, for example, text, voice, video or any combination of text, voice and video. The summarized content can be on numerous platforms, including, for example, web sites, desktop or mobile, email, mobile applications (apps) or for direct voice services, such as Alexa™ from Amazon, Inc. of Seattle Wash.

FIG. 2 shows the system 100′ of the home server 100, which performs the invention. The system 100′ may also include the cloud server 101, the market place server 104, the application server 105a and the browser extension server 105b, and/or portions thereof.

Initially, the system 100′ as shown in FIG. 2 includes the CPU 202, Storage/Memory 204, an interface 205 for receiving content, and facilitating the receiving of content, to be summarized, storage media for content 206, storage media for temporary storage 208, storage media for permanent storage 210, a communications module 212, one or more database(s) 214 for customers, who want summarized content, or want to obtain content from the market place, a rules and policies module 216, an administration module 218, a content processing system 220, an application (APP) 105ax and a browser extension (BE) 105bx. All of the aforementioned components of the system 100′ are linked either directly or indirectly to each other.

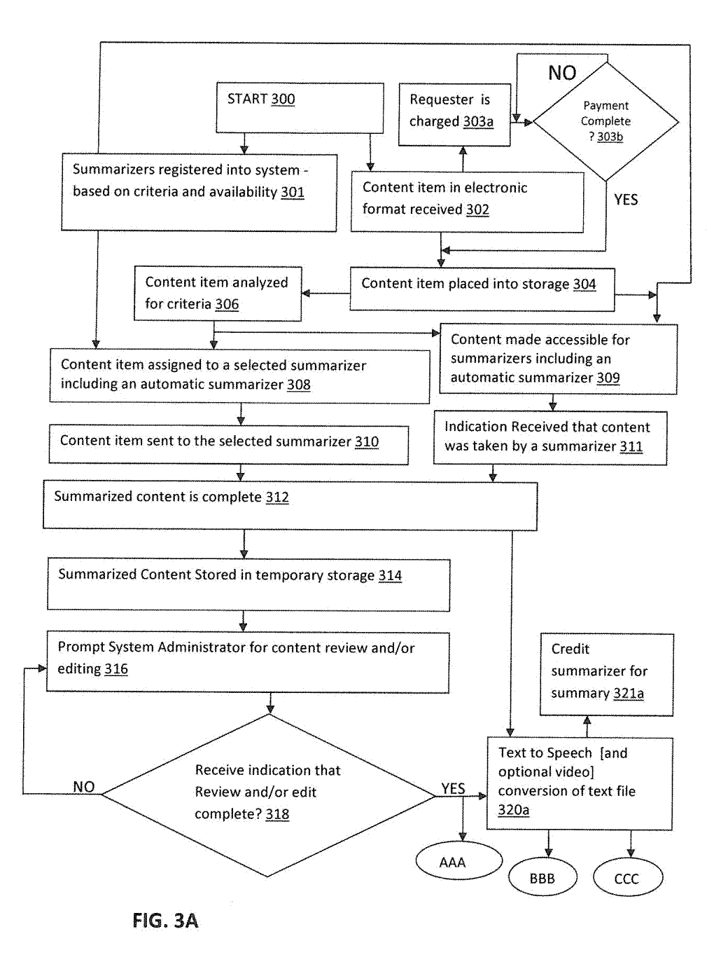

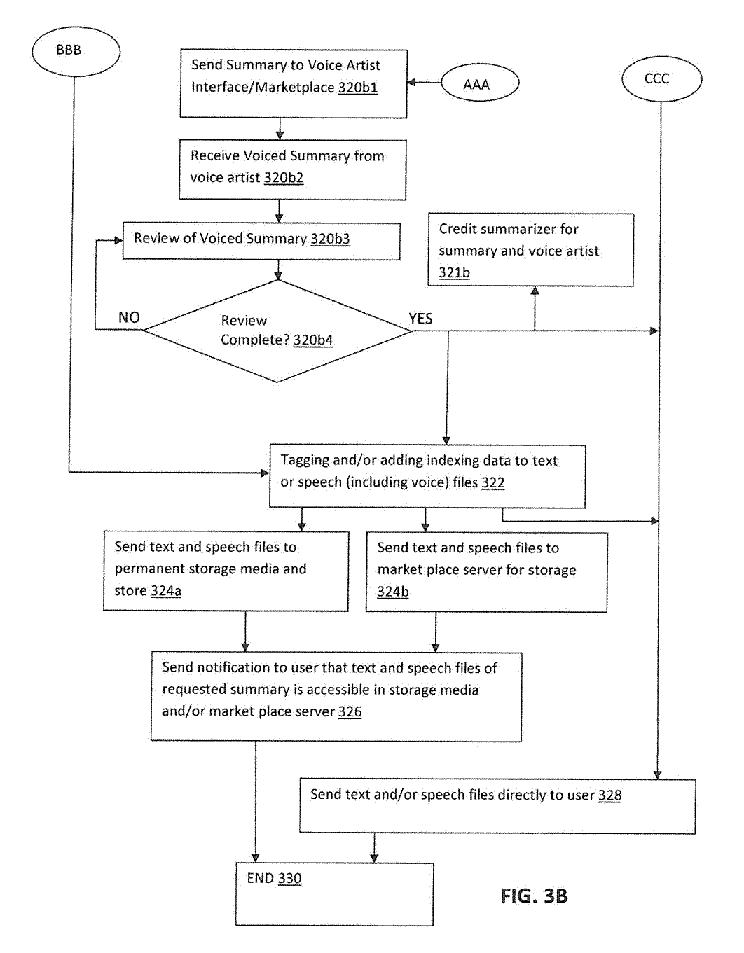

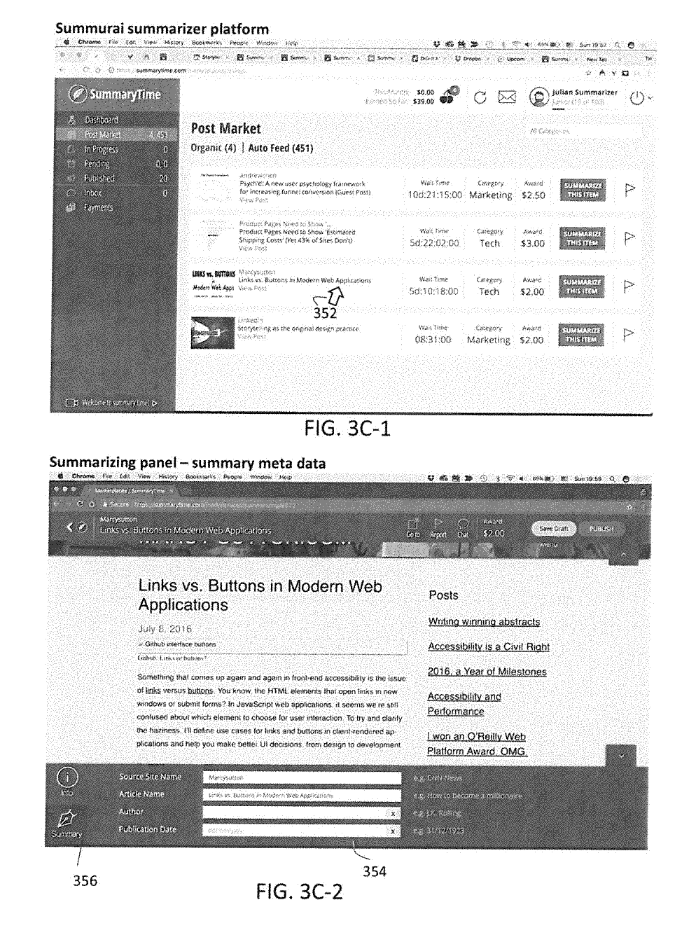

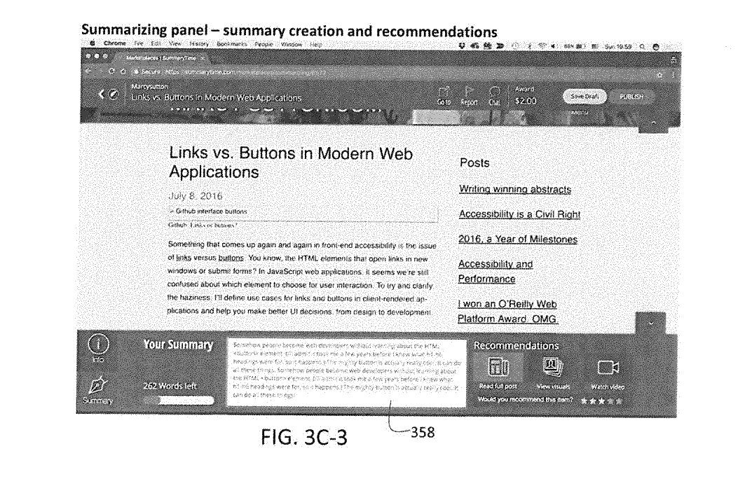

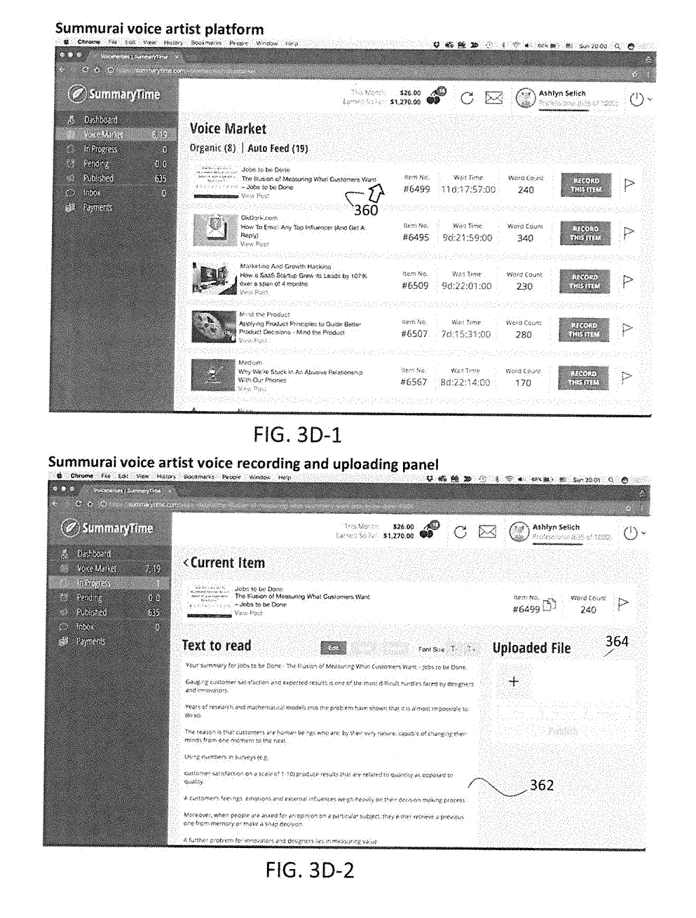

The Central Processing Unit (CPU) 202 is formed of one or more processors, including microprocessors, for performing the home server 100 and system 100′ functions and operations detailed herein, including controlling the interface 205, storage media for content 206, storage media for temporary storage 208, the permanent storage media 210, the communications module 212, the one or more database(s) 214 for customers, who want summarized content, or want to obtain content from the market place, the rules and policies module 216, the administration module 218 and the content processing system 220, along with the processes and subprocesses shown in FIG. 3, as detailed below. The processors are, for example, conventional processors, such as those used in servers, computers, and other computerized devices. For example, the processors may include x86 Processors from AMD and Intel, Xenon® and Pentium® processors from Intel, as well as any combinations thereof.

The storage/memory 204 is any conventional storage media. The storage/memory 204 stores machine executable instructions for execution by the CPU 202, to perform the processes of the invention.

The processors of the CPU 202 and the storage/memory 204, although shown as a single component for representative purposes, may be multiple components, and may be outside of the home server 100 and/or the system 100′, and linked to the network 50.

The interface 205 facilitates the input of content into the system 100′ and receives the content in the system 100′, so that the input content can be summarized. The interface 205 facilitates pasting of content by the various input entities 110, 111a-111d.

The content storage 206 is where content, and/or metadata representative of the content (which is stored for example in storage media such as cloud storage 101), received from users, is received, prior to its being sent for summarization.

The summary temporary storage media 208 holds summarized content and/or metadata therefor (e.g., the summarized content is then stored in storage media such as cloud storage 101), in both text, speech (voice or audio), and video files, until released by the system 100′, automatically (e.g., in accordance with rules and policies, from module 216), or manually, in accordance with instructions by a system administrator 102. The summarized content, is released, to one or both of the storage media for summary permanent storage 210, or the marketplace server 104, for example, as electronic content or as metadata, which links, to the actual content stored in storage media such as the cloud server 101. This storage media 208 is accessible, via the network(s) 50 by the administrator 102 or other computer or entity with the requisite credentials.

The storage media for permanent storage 210 stores the summaries of content produced by the summarizers 106a-106n in text, speech (voice), video files, and combinations thereof (once the files are approved for storage therein, from the temporary storage 208), and/or metadata for the summaries (which are stored, for example, in storage media such as cloud storage 101). The various users of the system 100′, e.g., users 110, 112 are provided with credentials (e.g., passwords) to access the storage media 210, to obtain the desired summarized content (e.g., files). Others, for example, represented by user 114, optionally, are also permitted to access the market place (storage media 210 or market place server 104) to look at the various content, available for purchase or which is accessible, free of charge. Content in the storage media 210 and the marketplace server 104, may be in various forms, and accessible via web pages, as well platforms such as, email, mobile applications (apps), social network (SN) feeds, via bots or via direct voice services, such as Alexa™ from Amazon, Inc. of Seattle, Wash.

The communications module 212 handles all communications to and from the system 100′ via the network(s) 50.

The database(s) 214 provide lists of customers of the system, with their status and activity, as well as summarizers 106a-106n (who typically register with the system 100′), including summarizers 106a-106n who are available at certain time periods, overall availability and the subject matter these summarizers 106a-106n are permitted to work with. Also stored in the database(s) 214 are user reports, workflow status data and the like.

The rules and policies module 216 stores various rules and policies for the system 100′, and all aspects of its operation. For example, these rules and policies may be used to determine that the subject matter of the content is inappropriate, and accordingly, will not be summarized by the system 100′. These rules and policies may be programmed into the module 216 by a system administrator 102 or the like.

The content processing system 220 is where content is summarized and then sent to either the requesting user and/or storage media 210 or the market place server 104, so that it can be accessed by users, such as users 110 and 112. The content processing system 220 is controlled by the CPU 202. The content processing system 220 includes, for example, a content analysis engine 231, which includes a processing module 231a and a content analyzing module 231b, an assignment module 232, a text to speech converter 233a, an automatic summarizing module 233b, a text to speech and video conversion module 234a, a voice artist interface/marketplace module 234b, a tagging/indexing module 235, a notification module 236, and a transmission module 237.

The content analysis engine 231 analyzes the content, for example, by examining the content, for its subject matter (subject), keywords, phrases, and the like, and to provide an optional word count for the content (module 231a) (used in compensating the summarizer 106a-106n as detailed below), and to classify the content by subject matter, so that the summarizer 106a-106n who receives this content for summarization is, for example, the best possible/available option. The analysis is performed, for example, by text or contextual analysis, and software for performing these processes, of the content analyzing module 231b. The assignment module 232 analyzes the available summarizers 106a-106n based on subject matter and matches the content with the available summarizers, for the best match, typically by subject matter. The CPU 202 is programmed to automatically send the content to be summarized to a certain summarizer 106a-106n, or an automatic summarizer 233b, as selected by the assignment module 232. Alternatively, the content analysis engine 231 can determine and post the subject matter, making the content available for multiple summarizers 106a-106n who want to provide a summary for the content, or send it to the automatic summarizer 233b.

A summarizing module 233a is, for example, a tool for use by the summarizers 106a-106n when creating their summaries. This summarizing module 233a sets up a form or template for the summary, that arranges various aspects of the content which is summarized, and includes an area for the summary, as well as an area for adding a personal note(s), adding recommendations, and links or attachments to the full (unsummarized) content. There are also areas for providing links to sources, to obtain photos, videos, and other graphics which may appear in the source article, e.g., the unsummarized content. The summarizing module 233a also includes notes from an editor as to the length of the summarized content and other rules for the summarized content. This module 233a is programmable by the system administrator 102.

An automatic summarized module 233b is a module which runs one or more algorithms for reading the requisite content, and producing a summary of this content. The algorithms, include for example, an automatic summarizer, commercially available as Intellexer™ API, from EffectiveSoft Corporation of San Diego, Calif. 92121 USA (www.inrellexer.com). This module 233a is programmable by the system administrator 102.

The text to speech and video converter 234a is a module, engine, computer component or the like, running a program or programmed to convert text files (of summarized content, as produced by, and typically received from, the requisite summarizer 106a-106n) to speech (voice) files.

A voice artist interface/marketplace module 234b is where summarized content, e.g., as text, is placed, so each item of summarized content can be read or voiced by a voice artist 108a-108n. the now read or voiced content is then returned to the system 100′ via this module 234b, which transfers the corresponding files, e.g., voice files and other associated files, if any, to the permanent storage 210, from where it may be transferred to the market place server 104.

The tagging/indexing module 235 either automatically, for example, by rules and policies, or permits manual tagging of the text and speech files of the summaries, and allows for the automatic or manual indexing of these files in either or both the storage media 210 and the market place server 104, and the cloud storage 101 (should metadata be stored in the storage media 210 and market place server 104 for the text, speech and/or video files).

The notification module 236 provides electronic communications, such as text messages, SMS (short message service) messages, Whatsapp™, email, smartphone, tablet desktop and other electronic messages/notifications, that the summarized content is now available and/or accessible and links to the summarized content, in one or more of the storage media 210 the storage media 210, the market place server 104, or the cloud server 101.

The transmission module 237 serves to transmit summarized content in various forms, such as web browser, web browser extension, email, mobile applications, for direct voice services, such as Alexa™ from Amazon, Inc. of Seattle, Wash. The transmission made by the transmission module 237, is, for example, to a mobile device, such as a smart phone, a computer, e.g., desktop, laptop, or tablet, or voice service device, such as Alexa™.

The system 100′ also includes the aforementioned application (APP) 105ax and browser extension (BE), for download by the users 110, 112.

Attention is now directed to FIGS. 3A and 3B show a flow diagram detailing computer-implemented processes in accordance with embodiments of the disclosed subject matter. Reference is also made to elements shown in FIGS. 1 and 2. The process and subprocesses of FIG. 3 include computerized processes performed by the system 100′, as well as other computers along the network 50, where indicated. The aforementioned processes are, for example, performed automatically or manually, or a combination thereof, and, for example, in real time.

The process begins at the START block 300. Prior to the START, the respective users, such as users represented by computers 110 and 112 have either downloaded the APP 105ax or the browser extension 105bx (from either the home server 100 or the application server 105a or the browser extension server 105b, respectively), onto their respective computers 110, 112, and the APP 105ax and/or browser extension (BE) 105bx (FIG. 4) is running on the computer. Also, content submitting devices/entities, such as devices/entities 111a-111d, auto-feeds 116, or any other tool that can be used to submit a request for the content to be summarized into a summary, such as add-ons, may be used for the aforementioned purpose.

Initially, at block 301, summarizers 106a-106n are registered into the system 100′(e.g., at database 214) the system, with, for example, status such as their current availability (in the case that content may be assigned to them for summarizing at block 308), and preferred subject matter, preferred languages. The process of block 301 is continuous, and from block 301, the process moves to blocks 308 or 309.

Also from block 300, a content item, e.g., in an electronic format, for example, in the form of URLs, e.g., links, original text, from content servers 100 or recorded media, represented by the compact disk 111ax, original summaries, online and off-line: 1) videos, 2) movies, 3) audio files, blog posts, online articles, ebooks, academic and scholarly papers, podcasts and other sources, both on-line and off-line, are received from the device 1110 of a user or devices 111a-111d, also associated with a user seeking content, or an auto-feed 116, is input into the system 100′, at block 302, for example, by being uploaded, or if text, pasted into an interface 205 (FIG. 2), or loaded automatically, submitted via web browser or browser extension, mobile app, or the like. The content received is typically in the form of electronic text, e.g., a text file, or other electronic format. The input content can also be tagged/indexed previously by the user (requestor) or an entity other than the user.

From block 302, the process moves to optional blocks 303a, 303b, and then to block 304. Optionally, at block 303a, the user who has submitted the content, also known as a “requestor” is charged, typically a monetary amount, for the summary request. The process can be such that until the payment is approved and received from the requestor, at block 303b, the process temporarily stops. Upon payment approval by the system 100′, e.g., administration module 218, the process moves to block 304, where it resumes. Payment can be, for example, a regular intervals, such as monthly, or other time period. However, should there be no charge or fee for the request, the process moves directly from block 302 to block 304.

Moving to block 304, either automatically from block 302, or once payment from the requestor is approved by the administrator module 218, the content item, for example, now obtained as an electronic document, is placed into storage, such as storage media 204, at block 304. Also at block 304, the content may be stored as metadata in the temporary storage 208, with the corresponding digital content stored in storage media represented by the cloud storage 101.

Optionally, from block 304, the process may move to block 309. At block 309, the content may optionally be made available to all summarizers 106a-106n, or an automatic summarizer (module 233b) until an indication is received (by the system 100′) that a summarizer 106a-106n or the automatic summarizer (module 233b) has taken this content for summarizing in accordance with the rules of the system, at block 311. From block 311, the process moves to block 312.

Returning to block 304, the process then moves to block 306. At block 306, the content analysis engine 231 then analyzes the content for criteria, such as subject matter, key words and/or phrases, word or letter combinations, and word count (optional). From block 306, the process moves to block 308.

At block 308, the assignment module 232, matches the criteria from the content analysis engine, with a summarizer 106a-106n, or the automatic summarizer (module 233b), and the content is assigned to the selected summarizer 106a-106n, or the automatic summarizer (module 233b). From block 308, the process moves to block 310, where the summarizer is sent the content item(s), e.g., typically in the form of a link to the content item, over a network(s) 50, or as part of a list. The summarizer 106a-106n or automatic summarizer (module 233b) then creates the summary of the content, and the process resumes from block 312.

For example, at block 310, a specific summarizer, such as one of summarizers 106a-106n, is provided a list of items (content items) to be summarized, as shown, for example, in the screen shot of FIG. 3C-1. The summarizer 106 then selects content item Links vs. Buttons in Modern Web Applications to Summarize, and upon activation of this listed item, by a click, swipe, contact or the like (represented by the arrow 352), a summarizing panel, shown by the screen shot of FIG. 3C-2, opens, and the text content of the content item is displayed, along with a box 354 in which metadata for the article is entered (input) by the summarizer. When this is complete, the summarizer clicks, swipes or contacts, or otherwise activates the “summary” box 356, and the summarizing panel, shown by the screen shot of FIG. 3C-3 displays. Here, the summarizer enters the summary of the content into block 358, and also provide a rating for the quality of the content which was summarized, and provide other comments.

At block 312, the summarized content is complete, as it received from the summarizer 106a-106n or automatic summarizer (module 233b). This summarized content is in formats including one or more of text (text files), audio or speech (audio/speech/voice files) and video (video files). The summarized content is placed (or transmitted) into the temporary storage 208, at block 314. Alternately, the summarized content is stored as metadata in the temporary storage 208, with the actual corresponding content stored in other storage media, such as the cloud storage 101.

Returning to block 306, alternately, the process moves to block 309, where the content, or metadata for its location is made available to the summarizers 106a-106n or sent to the automatic summarizer (module 233b) so that the content can be accessed for summarization. The process then moves to block 311, once an indication is received in the system 100′ that a summarizer 106a-106n or automatic summarizer (module 233b) has taken specific accessible content for summarization. The process the moves to block 312, and then block 314, as detailed above.

After block 314, a reviewer, such as the system administrator 102, is then prompted, at block 316, that the summarized content has been received and it is now accessible for review, editing and the like.

While in the temporary storage 208, the summarized content (or as obtained from the cloud storage 101, from metadata in the temporary storage 208) may be reviewed either automatically or manually, for example, by the system administrator 102. This is an optional process. Here, the summarized content may also be further edited, either automatically or manually, for example, by the system administrator 102.

The process then moves to block 318, where it is determined whether an indication of an approval of the text file has been received, for example, from the system administrator 102. If no, the process returns to block 316, from where it resumes. If an indication was received, the process moves to either of blocks 320a or 320b.

From block 318, or directly from block 312, the summarized content, for example, in a text file, is also converted to a speech (voice) file and optionally video files, by module 234a, at block 320a. The processes which are performed on the speech (voice) files, as detailed below, are also permissibly performed on the video files, also produced by the module 234a from the summarized content.

As the process moves from block 318 to block 320a, with the summarized content approved, there is the optional process, where the summarizer 106a-106n, if they created the summary, may receive monetary or other credit of value for their summarization, at block 321a. This optional process is administered, for example, by the administration module 218, and the amount for the summarizer may be based on the word count of the content, as performed by the word count module 231a. From block 320a, the process moves to either block 322 or block 328, as detailed below.

Returning to block 318, the process can also move to block 320b1, where, for example, the assignment module 232, sends the summarized content (summarized content item), for example, in text format, to the voice artist interface/marketplace module 234b. This text content item is made available for various voice artists (narrators) 108a-108n, to voice the text of the summary. For example, the various text summaries, requiring a voice artist (narrator) are displayed on the screen shot of FIG. 3D-1, and available to be voiced by the various voice artists. A voice artist, then selects the summarized text content item to be voiced, for example, in the screen shot of FIG. 3D-2, the summarized text content item “Jobs to be Done—The Illusion of Measuring What Customers Want” has been selected (represented by the arrow 360) by a voice artist, such as artist 108a, who voices the text (in box 362), and uploads the voice file (clicking, swiping, contacting or otherwise activating box 364), for storage by the system 100′, via the voice artist interface module 234b.

Specifically, once the text summary has been voiced, the system 100′, via the voice artist interface/marketplace module 234b, receives the voiced content item, at block 320b2. This voiced content item is then reviewed, at block 323b3. The process moves to block 320b4, where it is determined whether the review is complete. If no, the process returns to block 320b3, from where it continues, as described above. If yes, at block 320b4, the summarizer 106a-106n, if they created the summary, and/or the voice artist, may receive monetary or other credit of value for their summarization, at block 321b. This optional process is administered, for example, by the administration module 218, and the amount for the summarizer 106a-106n and/or voice artist 108a-108n may be based on the word count of the content, as performed by the word count module 231a.

From either or blocks 320a or 320b4, depending on the process, text and/or speech (including voice (files (and optional video files) which have not or were not to be tagged and/or provided with indexing data, as per block 322, are sent directly to the user who requested the summary (bypassing block 322), as the process moves to block 328. At block 328, the text and/or speech (including voice) (and optional video files) are sent directly to the user who requested the summary, for example, by the transmission module 237 in accordance with the requisite platform. Also at blocks 320a or 320b4, depending on the process, the process moves to block 322, where the files, e.g., text or speech (including voice) and/or video files are tagged and provided with indexing data, by the tagging/indexing module 235.

The text and speech files (and video files), as tagged and/or provided with indexing data, at block 322. These files are then sent to the permanent storage media 210, and stored therein, as files or metadata (if metadata, the actual files are stored in storage media such as the cloud server 101) according to the tagging/indexing, at block 324a, and/or the market place server 104, at block 324b. Also, tagged and/or indexing data provided files, or links to the storage media, such as cloud server 101, to these files, may be sent directly from the system 100′, to the user, e.g., user 110, as, the process moves to block 328, as discussed above.

Returning to blocks 324a and 324b, the process moves to block 326, where the notification module 235 sends an electronic communication, such as an e-mail text message, SMS (short message service) messages, WhatsApp′M, email, smartphone, tablet desktop and other electronic messages/notifications, or the like, which, for example, also includes a link to the location in the storage media 210, market place server 104, or cloud storage 101, where the summarized content files (e.g., text, voice and/or video) are located.

From blocks 326 and 328 (where the text and/or speech (including voice) (and optional video files) are sent (transmitted) directly, and, for example, automatically, to the user who requested the summary (e.g., user 110), for example, by the transmission module 237 in accordance with the requisite platform. The process moves to block 330, where the process ends. The process may be repeated for as many times as desired.

Alternately, a user, such as user 112, may desire to obtain already summarized content. In this case, the user typically purchases a credit for the content, or a subscription, administered by the administration module 218. This allows the user 112 to access the storage 210 or the marketplace server 104, and if necessary, the cloud storage 101, to obtain the desired content.

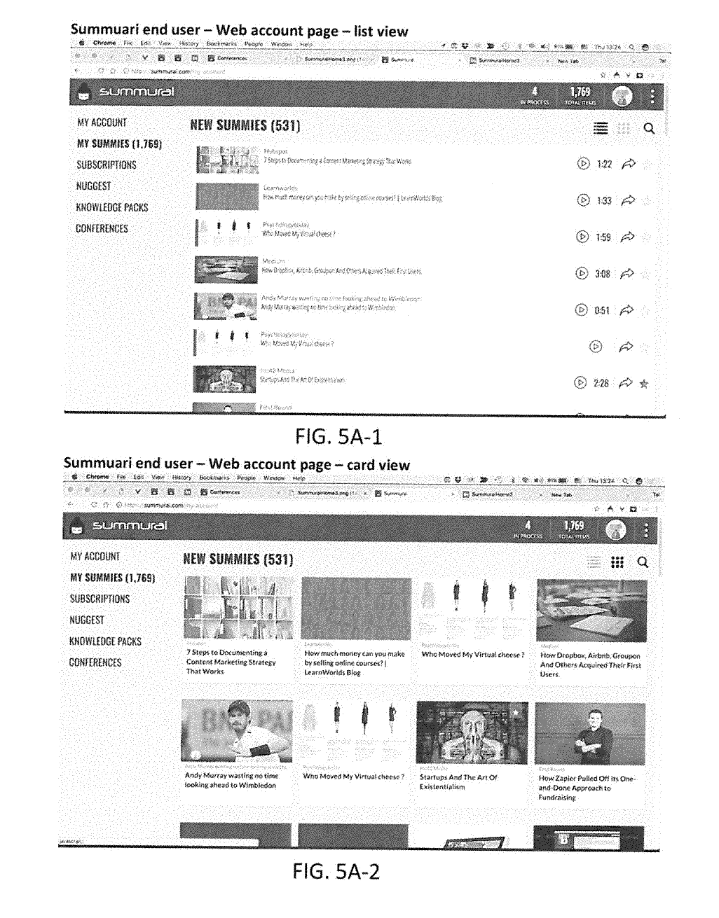

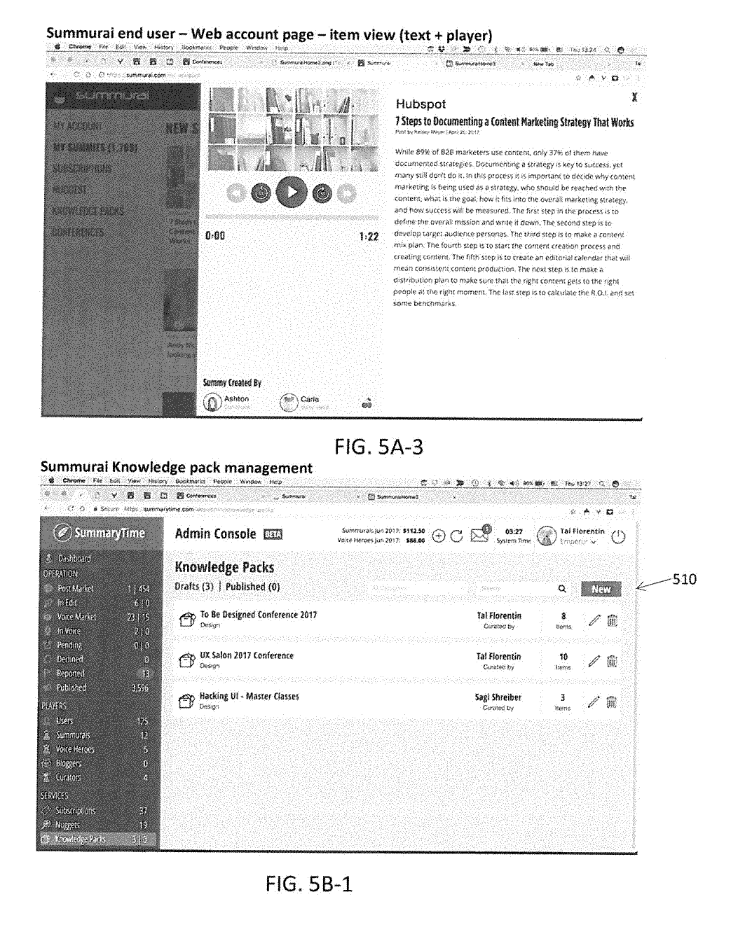

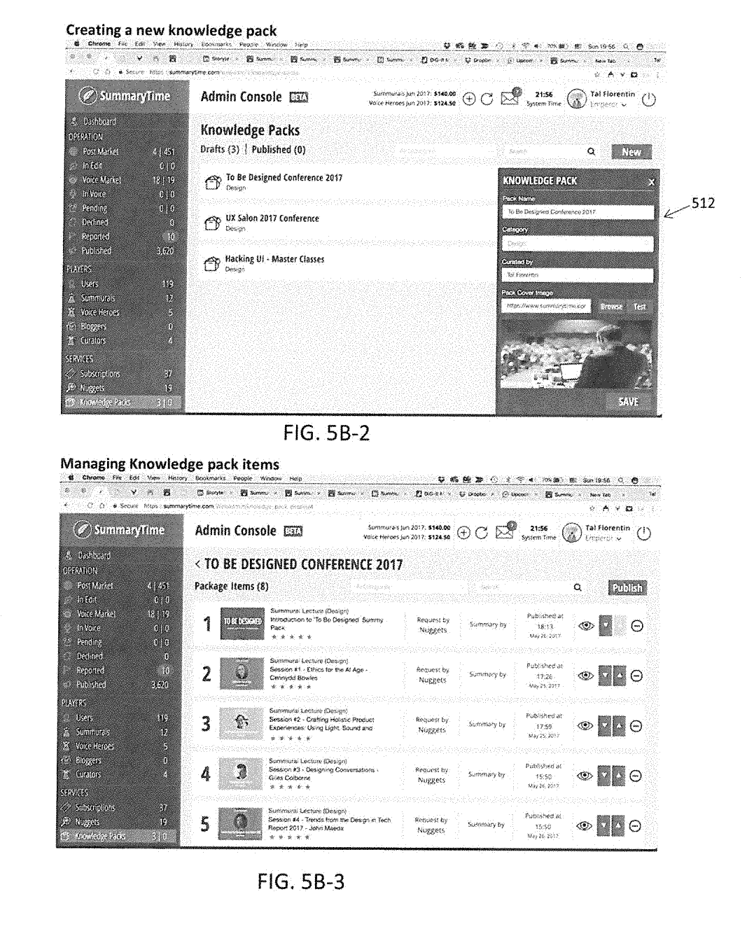

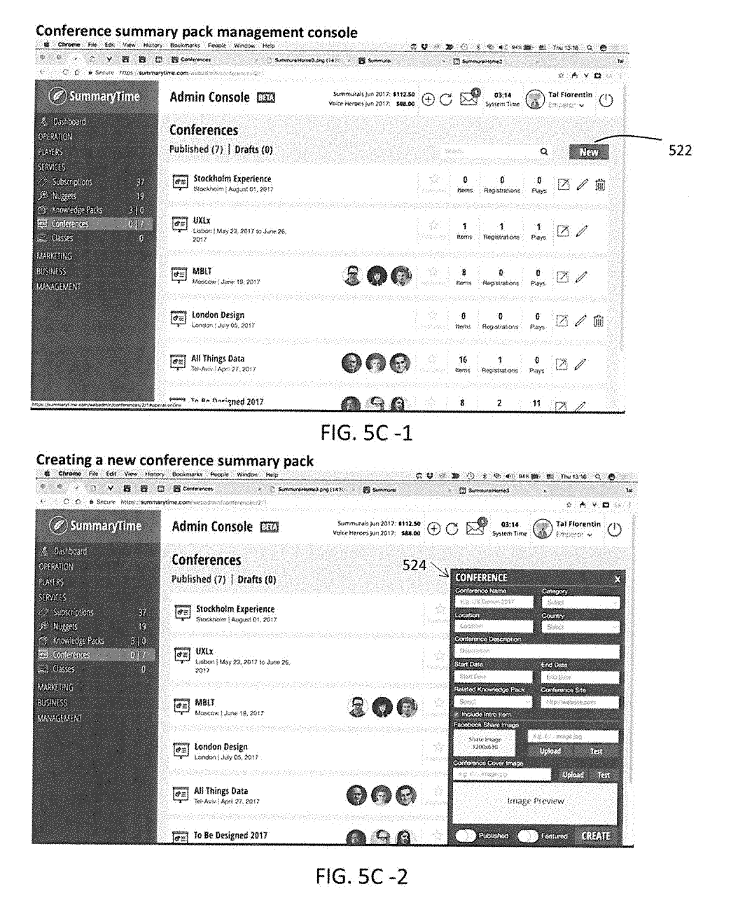

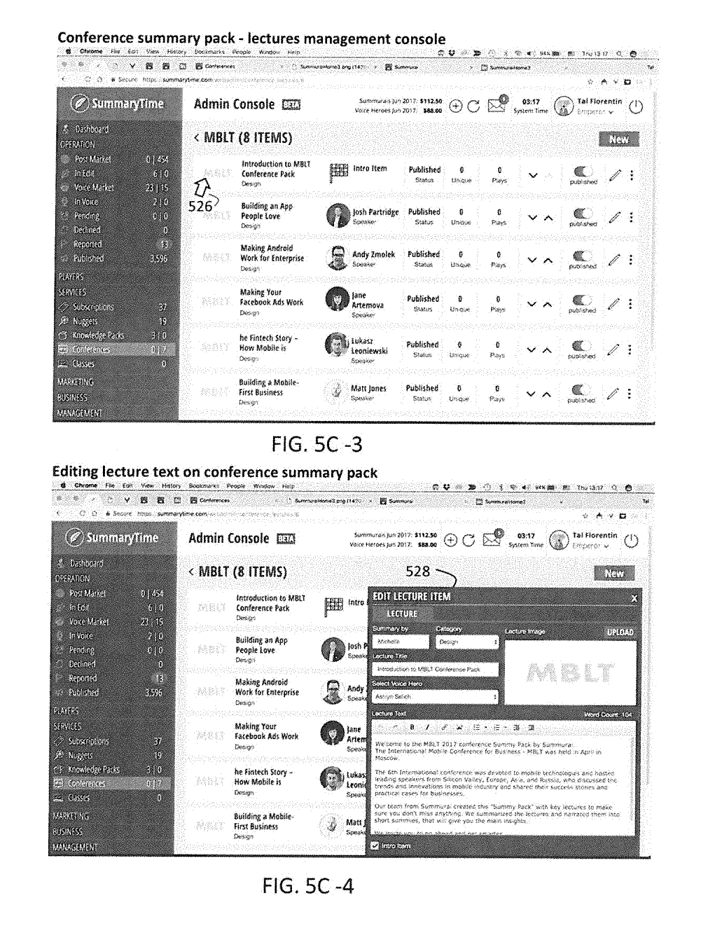

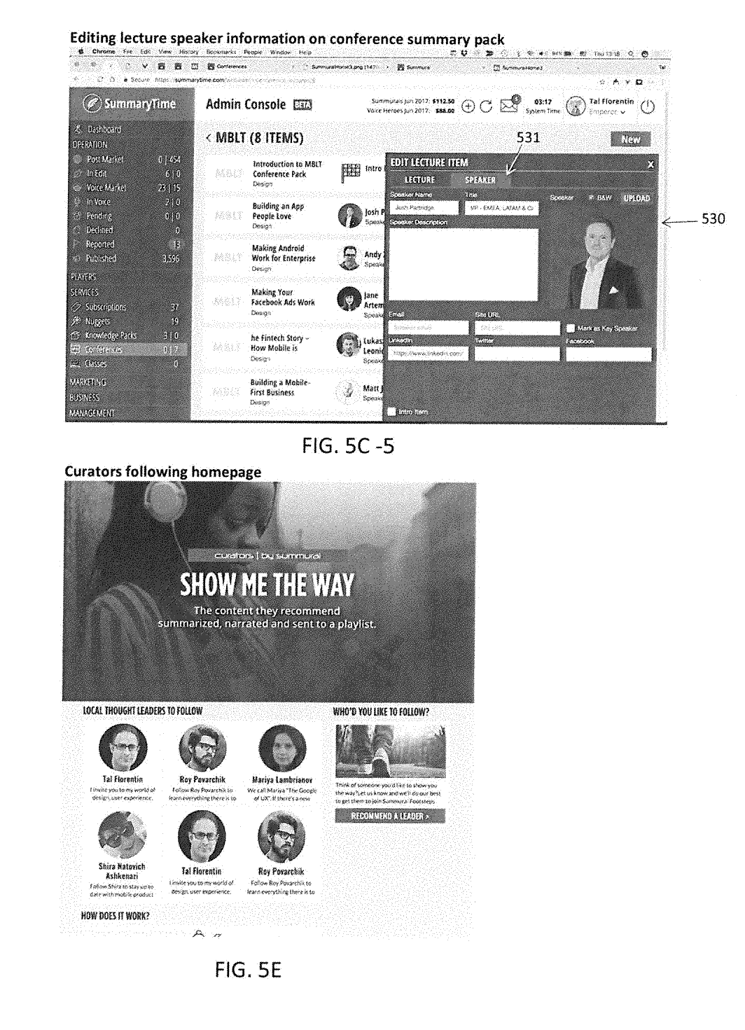

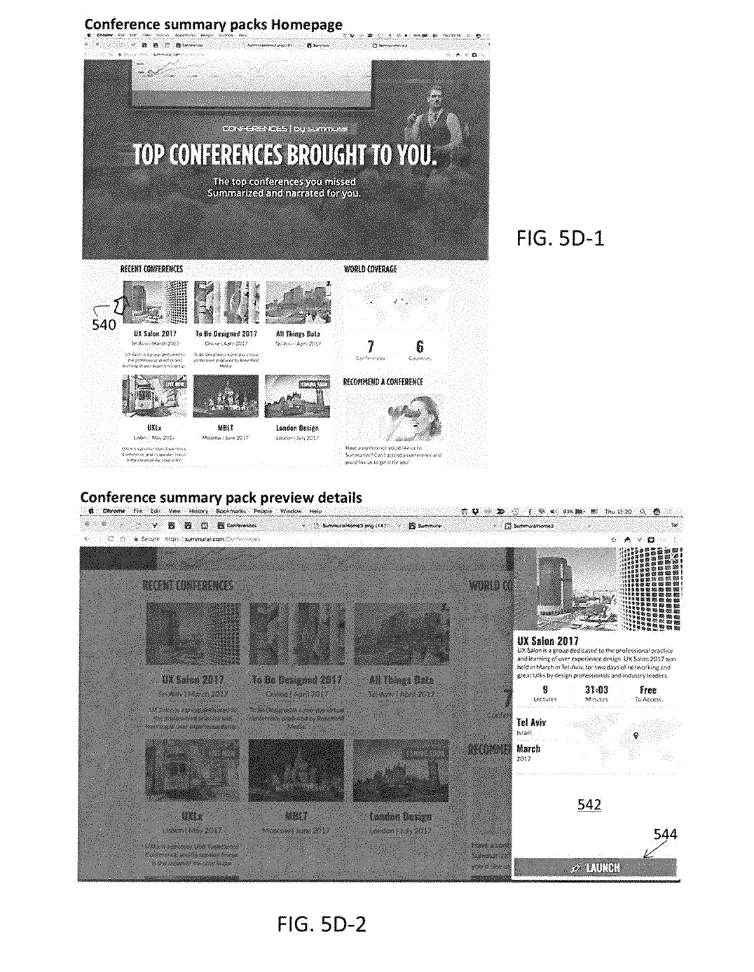

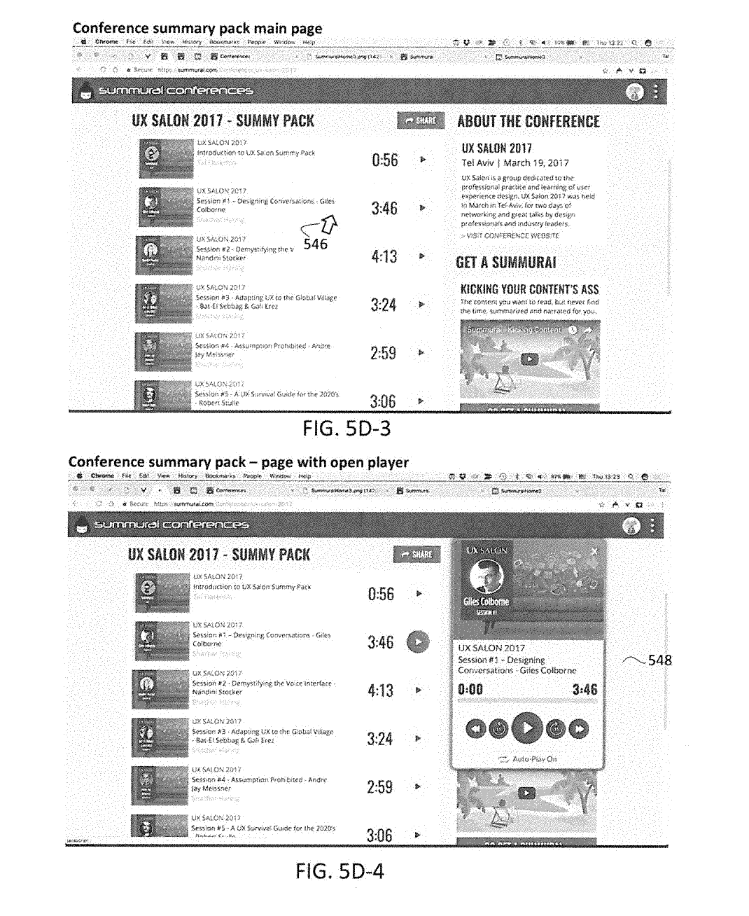

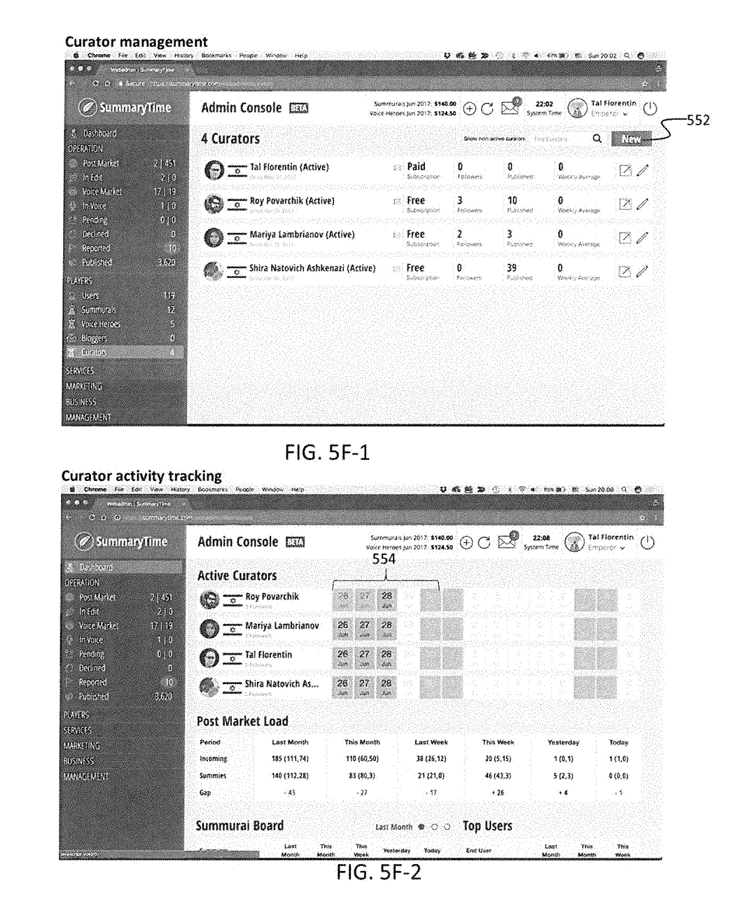

For example, the market place server 104 or storage 210 may host a web page, such as those shown by the screen shots of FIGS. 5A-1 and 5A-2. These screen shots display, for example, when a user logs into his account. In FIG. 5A-1 the summaries available for use, e.g., downloading or display, are provided as a list view (FIG. 5A-1) or a card view (FIG. 5A-2). The selected summary, for example, “7 Steps to Documenting a Content Marketing Strategy That Works” displays with a media player, for audio and video elements, along with a text of the summary, as shown in FIG. 5A-3.

At block 330, post processing of the summarized content, may be performed.

Exemplary post processing includes the creation of knowledge packs. A knowledge pack is a group of summarized content items, which are grouped together based on one or more criteria, genres and the like. These knowledge packs are, for example, arranged by packagers 107a-107n (FIG. 1). The summarized content items can be a pack of items from the same source, a pack of items from the same period of time and a pack of items that are based on the same or similar subject(s). Users may view these knowledge packs, for example, by accessing the market place server 104. The knowledge packs can also be sent to users into their interface to browse and consume the content. A packager 107, via the administration module 218, can manually or automatically create these knowledge packs, for example, by connecting multiple items to the same group.

For example, when it is desired a packager 107 can create a knowledge pack, by directing his browsing application to the URL of the home server 100, and obtaining the web page, run by the administration module 218, for creating a knowledge pack. An example web page is shown, for example, in the screen shot of FIG. 5B-1. When a new knowledge pack is to be created, the authorized user administrator clicks, swipes, contacts or otherwise activates (collectively known as a user activation hereinafter) the “New” button 510, and a box 512 appears on the web page, as shown in the screen shot of FIG. 5B-2. The knowledge pack can be given a name or title, and provided with metadata for the knowledge pack and a cover photograph added, into this box 512. Moving to the screen shot of FIG. 5B-3, the summarized content items which make up the knowledge pack can be ordered for display, by the authorized user.

Similar to the knowledge packs, conference packs can be created, for example, by packagers 107 (represented by computers 107a-107n). These conference packs include, for example, summarized lectures from conferences, meetings, events, and the like. The lectures are summarized and the summaries are narrated. Like the knowledge packs, once ready, all of the summarized content items are grouped into a single pack of items and offered to various users. These conference packs are also offered online to end users, also known as content consumers (via websites, mobile apps, and the like. Users receive the conference packs either free or as a paid service. The summarized content items are available as voice, text, or combinations thereof. Conference lecture items may include speaker details, such as profile and contact information, lecture slides, lecture video, questions and answers about the lecture or comments and the like.

These conference packs are managed, for example, by the administration module 218. For example, in FIG. 5C-1, there is shown a screen shot of all of the conference packs, such as those from the “Stockholm Experience”, “UXLx”, through “To Be Designed 2017”. When a new conference pack is entered into the system 100′, the “new” button 522 is clicked, swiped, contacted or otherwise activated (collectively known as a user activation hereinafter), and the screenshot of FIG. 5C-2 appears with a box 524, in which a new conference pack can be entered by an authorized party.

Additionally, the screen shot of FIG. 5C-3 shows a lecture management console where the summarized lectures of the conference pack, here, for the conference pack of the MBLT Conference (shown in FIGS. 5C-1 and 5C-2). The lectures which have been summarized in the conference pack begin with the first item, “Introduction to MBLT Conference Pack.” By a user activation of this first item (shown by the arrow 526), the screen shot of FIG. 5C-4 is displayed. In FIG. 5C-4, a box 528 shows the summary for this first item, which as displayed, may be created and/or edited by the authorized party. Metadata may be added, such as the name of the summarizer and the category of the summary, as well as a cover image for the summary. Similarly, should the second item “Building an App People Love” be user activated, and opened, the screen shot of FIG. 5C-5 displays. Here, a box 530 appear (via activation of a tab 531), where details as to the speaker may be entered by the authorized party.

When a user wants to view a conference summary pack, the user's browsing application is directed to a destination URL, such as that for the marketplace server 104 (www.mpserver.com) or other web site, and a home page of the conference packs displays, as shown in FIG. 5D-1. The user then activates the desired conference pack for the conference “UX Salon 2017—Tel Aviv March 2017”, as indicated by the arrow 540, and a box 542 for the “UX Salon 2017—Tel Aviv March 2017” appears on the subsequent screen shot of FIG. 5D-2, which now displays. When the “LAUNCH” button 544 is activated, the individual summaries for the “UX Salon 2017—Tel Aviv March 2017”, are listed, as shown in the screen shot of FIG. 5D-3. Should an audio summary be selected, such as “Session #1—Designing Conversations-Giles Colborne”, by a user activation, represented by arrow 546, a media player 548 launches, to play the audio Summary, as shown by the screen shot of FIG. 5D-4.

There may also be a subscription service for the summaries, either individually, in knowledge packs, other packaging or the like. Here, for example, the user seeking content, such as user 112, 114, requests content from a specific source, e.g., a specific curator, blogger, student, or web site, for example CNN.com, and a specific subject, Major League Baseball news. The request may also be from a system 100′ provided list of subjects, topics, bloggers, curators and the like. The system 100′, for example, automatically loads the summaries which meet the user's request, that are published by the requested source. The requested summaries are sent to the subscriber, e.g., user 112, 114, for example, as a push, rather than the user pulling down the desired summaries. The subscription may be a free or paid service.

The curators 109a-109n (FIG. 1) are various individuals who are specialists or experts in one or more subjects. Each curators 109a-109n has an account with the system 100′. Each curator sends items they recommend to the system 100′ for the aforementioned summarizing and narration process, detailed above. For example, users, such as user 114 may to subscribe one or more curators and follow their recommendations, and get the summarized and narrated content to the items that each curator, for example, by push. Each summary associated with a particular curator 107a-107n may be in a list of summaries and/or knowledge packs, and may be stored for access in the cloud storage 101 or the marketplace server 104. Users may subscribe to a particular curator, as administered by the system 100′, such that the system provides the curator's summaries to the subscribing or otherwise requesting user.

For example, each user may activate their account, for example, in the marketplace server 104, which displays as a web page, such as the screen shot of FIG. 5E, showing the curators that the user is following. Each curator is linked to various summaries for their content, so activating a box for that curator, by click, swipe, contact or other activation, will cause a list of summarized content associated with that curator to display on a subsequent page/panel or other electronic display.

The administration module 218, for example, may also provide for curator management, as shown for example, in the screen shots of FIGS. 5F-1, 5F-2 and 5F-3. FIG. 5F-1 shows a list of curators associated with the system 100′ and the ability to add a new curator, by an activation of the “New” button 552. Curator activity is tracked in FIG. 5F-2, where each curator has either an item to be published on a date (in green in a date box 554) or an item outstanding (in red in a date box 554). FIG. 5F-3 shows a user interface (UI) for a curator, with a list of items to be sent for summary 556, and an assignment of items to be summarized to be available on a particular date, as per the boxes for the week of June 25 to July 1.

Alternately, students can be the summarizers 106a-106n, as shown in FIG. 1. For example, students can produce summaries of academic lectures, provide course summaries, and organize and narrate these summaries, for example, in a packed form, such as per course or in a knowledge pack (as detailed above).

The system 100′ also provides a service for bloggers 109a-109n. Like the curators, the bloggers provide specific content to the system to be summarized. The bloggers can place a player and subscription element on their website/blog. Whenever a new blog item is published, the blog item will be sent as a request to the system 100′, where it will be summarized in accordance with the process detailed above (in FIGS. 3A and 3B). Each blog summary, list of summaries and/or knowledge packs, may be stored for access in the cloud storage 101 or the marketplace server 104. Users may subscribe to a particular blogger, as administered by the system 100′, such that the system provides the blogger's summaries to the subscribing or otherwise requesting user.

Alternately, individual organizations may collect their summarized content items and make these summarized items available on a private archive, available to the organizations members.

In alternative embodiments, all of the summarized content, including narrated summarized content will be archived. The archive may be in the cloud storage 101 or other storage media. The summarized content items may be available with or without charge, or combinations thereof. For example, newer summaries may be available for a fee, while older summaries may be available for no charge. Or alternatively, a one-time or monthly or other payment for accessing the content archive is required.

Each of the summaries (summarized content items) when access thereto is requested by a user, may launch in a template, the template including spots for content, such as information or ads. When the template displays to the user, the summarized item along with activatable content, with underlying links to a destination, typically a web page over the network(s) 50. When the activatable content is activated, by a “click” (mouse or pointing device), swipe or contact (on a touch screen display), the browsing application of the user, is directed to the destination web page, associated with the activatable content. The content and activatable link and destination are typically selected based on various rules. For example, if the rules are based on context, should the summary displayed be for automobiles, the activatable content may be for new cars, and accordingly, an activatable link to Volkswagen®, a leading automobile seller. Also, for example, should the advertisements be pay per click advertisements, they may offset the cost to the summary seeking user, as the advertiser or information provider, pays some or all of the cost for the summary, thus, reducing costs to the end user (content consumer).

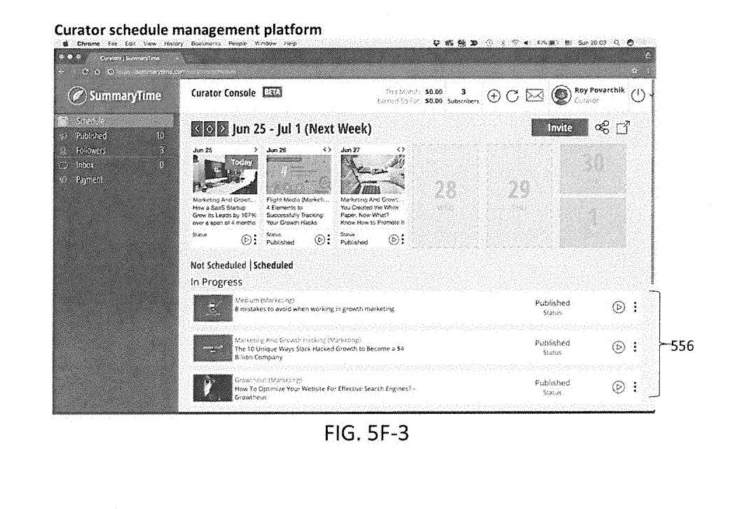

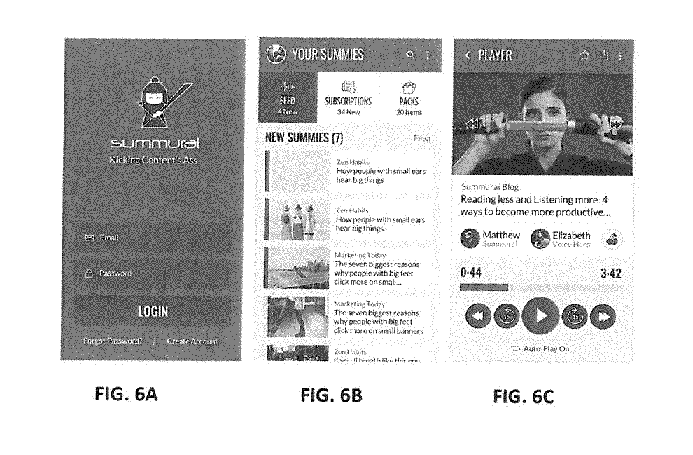

FIGS. 6A, 6B and 6C are screen shots of a mobile interface, over which a user, such as mobile user 110, 112, 114, can access the system 100′ and/or the marketplace server 104, to obtain summaries, including summary subscriptions, conference and knowledge packs, and other summaries, as detailed above. FIG. 6A shows a mobile log-in screen. FIG. 6B shows a playlist, with various summaries, and FIG. 6C shows a summary and a media player launched for audio and video portions of the summary.

All of the summaries produced by the system 101′ are, for example, stored in the archive server (or archive) 103, for example, accessible over the network(s) 50 and having, for example, a URL of www.aserver.com. This archive server 103 can be open to the public or only those with specific access thereto, and with or without payment, subscription or the like. The summaries are typically tagged, indexed, and the like, so as to be searchable by computers and the like. The summaries are consumable in formats such as text, audio, video and combinations thereof. These summaries may be consumed by web devices, mobile devices, and the like.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data.

Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method for providing summarized content for consumers comprising:
receiving content;
automatically analyzing the content;
automatically determining the summarizer for the content based on the analysis of the content;
automatically sending the content to the determined summarizer for summarization;
receiving a summary of the content from the summarizer; and,
rendering the summary of the content to a medium such that the summary is accessible to consumers.

2. The method of claim 1, wherein the automatically analyzing the content includes analyzing the content for one or more of subjects, keywords and phrases.

3. The method of claim 2, wherein the automatically determining the summarizer for the content includes selecting at least one of an automatic summarizer or a manual summarizer for the content.

4. The method of claim 3, wherein the automatically sending the content to the determined summarizer includes: 1) sending the content to a selected individual summarizer; or, 2) sending the content to a storage media for access by multiple summarizers, when a manual summarizer for the content has been selected.

5. The method of claim 4, wherein, upon receiving a summary of the content from the summarizer, providing the summary to a voice artist interface for access by voice artists to provide audio to the content.

6. The method of claim 5, wherein the summary including the audio is received from the voice artist, such that the summary can be rendered to the medium such that the summary is accessible to consumers.

7. The method of claim 4, wherein the rendering the summary of the content to a medium includes providing the summary of the content to a storage media.

8. The method of claim 7, wherein the storage media includes one or more of a marketplace server and an archive server.

9. The method of claim 4, wherein the rendering the summary of the content to a medium includes transmitting the summary of the content to a device associated with at least one of the consumers.

10. The method of claim 9, wherein the transmission is performed automatically.

11. The method of claim 1, wherein the summary of the content is in at least one format including, text, audio, video, and combinations thereof.

12. A computerized system for providing summarized content for consumers, comprising:
a storage medium for storing computer components; and,
a computerized processor for executing the computer components comprising:
a first computer component for receiving content;
a second computer component for automatically analyzing the content;
a third computer component for automatically determining the summarizer for the content based on the analysis of the content;
a fourth computer component for automatically sending the content to the determined summarizer for summarization;
a fifth computer component for receiving a summary of the content from the summarizer; and,
a sixth computer component for rendering the summary of the content to a medium such that the summary is accessible to consumers.

13. The computerized system of claim 12, wherein the second computer component for automatically analyzing the content analyzes the content for one or more of subjects, keywords and phrases.

14. The computerized system of claim 13, wherein the third computer component for automatically determining the summarizer for the content selects at least one of an automatic summarizer or a manual summarizer for the content.

15. The computerized system of claim 14, wherein the fourth computer component for automatically sending the content to the determined summarizer: 1) sends the content to a selected individual summarizer; or, 2) sends the content to a storage media for access by multiple summarizers, when a manual summarizer for the content has been selected.

16. The computerized system of claim 15, additionally comprising, a seventh computer component for providing the summary to a voice artist interface for access by voice artists to provide audio to the content, for a received summary of the content from the summarizer.

17. The computerized system of claim 16, wherein the fifth computer component additionally receives the summary including the audio from the voice artist, such that the summary can be rendered to the medium such that the summary is accessible to consumers.

18. The computerized system of claim 15, wherein the sixth computer component renders the summary of the content to a medium by providing the summary of the content to a storage media.

19. The computerized system of claim 18, wherein the storage media includes a marketplace server.

20. The computerized system of claim 15, wherein the sixth computer component renders the summary of the content to a medium by transmitting the summary of the content to a device associated with at least one of the consumers.

21. The computerized system of claim 20, wherein the transmission is performed automatically.

22. The computerized system of claim 12, wherein the summary of the content is in at least one format including, text, audio, video, and combinations thereof.

23. A computer usable non-transitory storage medium having a computer program embodied thereon for causing a suitable programmed system to providing summarized content for consumers via a network, by performing the following steps when such program is executed on the system, the steps comprising:
receiving content;
automatically analyzing the content;
automatically determining the summarizer for the content based on the analysis of the content;
automatically sending the content to the determined summarizer for summarization;
receiving a summary of the content from the summarizer; and,
rendering the summary of the content to a medium such that the summary is accessible to consumers.

24. The computer usable non-transitory storage medium of claim 23, wherein the automatically analyzing the content includes analyzing the content for one or more of subjects, keywords and phrases.

25. The computer usable non-transitory storage medium of claim 24, wherein the automatically determining the summarizer for the content includes selecting at least one of an automatic summarizer or a manual summarizer for the content.

26. The computer usable non-transitory storage medium of claim 25, wherein the automatically sending the content to the determined summarizer includes: 1) sending the content to a selected individual summarizer; or, 2) sending the content to a storage media for access by multiple summarizers, when a manual summarizer for the content has been selected.

27. The computer usable non-transitory storage medium of claim 26, wherein, upon receiving a summary of the content from the summarizer, providing the summary to a voice artist interface for access by voice artists to provide audio to the content.

28. The computer usable non-transitory storage medium method of claim 27, wherein the summary including the audio is received from the voice artist, such that the summary can be rendered to the medium such that the summary is accessible to consumers.

29. The computer usable non-transitory storage medium of claim 26, wherein the rendering the summary of the content to a medium includes: 1) providing the summary of the content to a storage media; or, 2) automatically transmitting the summary of the content to a device associated with at least one of the consumers.

30. The computer usable non-transitory storage medium of claim 29, wherein the storage media includes a marketplace server.

31. The computer usable non-transitory storage medium of claim 23, wherein the summary of the content is in at least one format including, text, audio, video, and combinations thereof.
